(19) United States
(12) Patent Application Publication
(10) Pub. No.: US 2005/0020117 A1
(43) Pub. Date: Jan. 27, 2005

(54) Socket for electronic part

(75) Inventor: Sentaro Motohashi, Yokohama-shi (JP)

Correspondence Address: LORUSSO & LOUD, 3137 Mt. Vernon Avenue, Alexandria, VA, 22305, US

(73) Assignee: OTAX CO., LTD.

(21) Appl. No.: 10/862,357

(22) Filed: Jun. 8, 2004

(30) Foreign Application Priority Data
Jul. 23, 2003 (JP) 2003-200634

(51) Int. Cl. H01R 13/62

(52) U.S. Cl. 439/331

(57) ABSTRACT

In a socket for an electronic part, each electrode portion includes a leaf spring portion which is disposed by bending a conductive plate material substantially into a U-shape and facing an opening part in a direction substantially perpendicular to the thickness direction of a socket body, a first contact which is unitarily provided at one free end of the leaf spring portion and which is held in electrical contact with the corresponding electrode terminal of the electronic part, and a second contact which is unitarily provided at the other free end of the leaf spring portion and which is held in electrical contact with the corresponding electrode terminal of a printed circuit board. The leaf spring portion includes a horizontally extending portion which is arranged substantially in parallel with the horizontal surface of the printed circuit board, a coupling portion which is unitarily provided at one end part of the horizontally extending portion in the thickness direction of the socket body, and an obliquely extending portion which is unitarily provided at the end part of the coupling portion so as to oppose to the horizontally extending portion and to obliquely rise up toward the electronic part. Engagement pieces which are held in engagement with engagement grooves provided in partition walls are formed on both the sides of the coupling portion unitarily with this coupling portion.

### BACKGROUND OF THE INVENTION

1. Field of the Invention

The present invention relates to a socket for an electronic part. More particularly, it relates to a socket which is so designed that, when the electronic part of a CPU, an MPU or the like is pushed against a socket body, the electrode terminals of the electronic part and those of a printed circuit board can be electrically connected through electrode portions disposed in the socket body.

2. Description of the Related Art

A known socket of this kind for an electronic part is so constructed that, when the electronic part is pushed against a socket body, the electrical contact between the electrode terminals of the electronic part and the electrode portions of the socket body is maintained, while the electrode portions of the socket body are connected to the electrode terminals of a printed circuit board (refer to, for example, U.S. Pat. No. 6,004,141).

With the socket for the electronic part, a push member is coupled to one end edge portion of the socket body, and it is swung about the coupled position, thereby to urge the electronic part onto the socket body side. In this state, a hook which is mounted to the other end of the push member is engaged on the engaging portion of the socket body. Thus, the electronic part is fixedly mounted to the socket body, and the electrical contact between the electrode terminals of the electronic part and the electrode portions of the socket body is maintained.

As shown in FIG. 15, each of the electrode portions of the socket body includes a sliding contact 10 which comes into contact with the corresponding electrode terminal of the electronic part, and a spring contact 20 which is formed of a leaf spring and which lies in contact with the sliding contact 10. The sliding contact 10 and the spring contact 20 are arranged in opposition within the recess 40 of the socket body 30.

In the electrode portion, when the electronic part is pushed against the socket body 30, the contact point 50 between the sliding contact 10 and the spring contact 20 is slidably moved in a direction b perpendicular to a pushing direction a. In turn, the degree of intimateness of the contact between the sliding contact 10 and the spring contact 20 increases in proportion to the amount of movement of the sliding contact 10 owing to the resilience of the spring contact 20.

According to the socket for the electronic part thus constructed, the inferior electrical contact between the electrode terminals of the electronic part and the electrode portions of the socket body is not induced by the attachment or detachment of the electronic part. Moreover, the electrode portions are comparatively simple in structure and are easy in fabrication.

The socket for the electronic part having such a construction, however, has been still unsatisfactory as stated below. Since each electrode portion of the socket body has a so-called “two-piece contact structure” consisting of the sliding contact 10 and the spring contact 20, the contact point 50 between the sliding contact 10 and the spring contact 20 might unintentionally slide to make a contact resistance unstable, depending upon the state of the contact position between the two. Besides, the contact parts have complicated shapes, and the two pieces of parts are required, so that the workability and assemblability of the contact parts are inferior, and the cost thereof is comparatively high. Further, since the displacement of the spring contact 20 is absorbed by the thickness of the socket body 30, the socket body 30 itself must be thick enough to absorb the displacement of the spring contact 20.

The present invention has been made in order to eliminate such difficulties, and it has for its object to provide a socket for an electronic part, in which the workability and assemblability of electrode portions are favorable, which attains a stable contact resistance, which can reduce the thickness of a socket body itself and which is comparatively low in cost.

### SUMMARY OF THE INVENTION

In order to accomplish the object, the socket of the present invention for use with an electronic part consists in a socket for an electronic part, having electrode portions which are disposed in recesses of a socket body and which are connected to electrode terminals of the electronic part and electrode terminals of a printed circuit board; each of the electrode portions comprising a leaf spring portion which is disposed by bending a plate material substantially into a U-shape and facing an opening part in a direction substantially perpendicular to a thickness direction of the socket body, a first contact which is unitarily provided at one free end of said leaf spring portion and which is held in electrical contact with the corresponding electrode terminal of one of the electronic part and the printed circuit board, and a second contact which is unitarily provided at the other free end of said leaf spring portion and which is held in electrical contact with the corresponding electrode terminal of the other of the electronic part and the printed circuit board; an electrical contact portion of said first contact with the corresponding electrode terminal of said one of the electronic part and the printed circuit board being existent at an oblique upper position as viewed from an electrical contact portion of said second contact with the corresponding electrode terminal of said other of the electronic part and the printed circuit board.

Besides, said leaf spring portion in the socket of the present invention for use with an electronic part includes a horizontally extending portion which is arranged substantially in parallel with a horizontal surface of said other of the printed circuit board and the electronic part, a coupling portion which is unitarily provided at one end part of said horizontally extending portion in the thickness direction of the socket body, and an obliquely extending portion which is unitarily provided at an end part of said coupling portion so as to oppose to said horizontally extending portion and to obliquely rise up toward said one of the electronic part and the printed circuit board; said first contact is constructed by bending a distal end part of said obliquely extending portion toward said one of the electronic part and the printed circuit board; and said second contact is constructed by bending a distal end part of said horizontally extending portion toward said other of the electronic part and the printed circuit board.

Further, a dimension of said obliquely extending portion in a lengthwise direction thereof in the socket of the present invention for use with an electronic part is set to be longer than a dimension of said horizontally extending portion in a lengthwise direction thereof.

Besides, said leaf spring portion in the socket of the present invention for use with an electronic part includes first engagement pieces which are provided unitarily with its own side parts toward sidewalls of the recess, and said first engagement pieces are held in engagement with first engagement grooves which are provided in the sidewalls.

Further, said leaf spring portion in the socket of the present invention for use with an electronic part includes shafts which are provided unitarily with its own side parts toward sidewalls of the recess, and said shafts are rotatably supported by bearings which are provided in the sidewalls.

Besides, said leaf spring portion in the socket of the present invention for use with an electronic part includes extension pieces which are provided unitarily with its own side parts toward sidewalls of the recess, and second engagement pieces which are provided unitarily with end parts of said extension pieces in parallel with the sidewalls, and said second engagement pieces are held in engagement with second engagement grooves which are provided in the sidewalls.

According to the socket of the present invention for use with an electronic part, each electrode portion is constructed of a single piece and is structurally simplified, so that the workability and assemblability of the electrode portion can be sharply enhanced, and the cost thereof becomes comparatively low. Moreover, the electrical contact portion between each first contact and the corresponding electrode terminal of the electronic part (or a printed circuit board) exists at an oblique upper position as viewed from the electrical contact portion between each second contact and the corresponding electrode terminal of the printed circuit board (or the electronic part), so that the dimension of a leaf spring portion in the lengthwise direction thereof can be set large. In turn, even when the thickness of a socket body itself is small, each electrode terminal of the electronic part and the corresponding electrode terminal of the printed circuit board can be reliably brought into electrical contact, and a stable contact resistance can be attained.

### BRIEF DESCRIPTION OF THE DRAWINGS

FIG. 1 is a side view showing an example of an electronic part;

FIG. 2 is a perspective view of a socket for an electronic part showing an embodiment of the present invention;

FIG. 3 is an explanatory view showing the situation of mounting of electrode portions into the recesses of a socket body in the embodiment of the present invention;

FIG. 4 is a perspective view of the electrode portion in the embodiment of the present invention;

FIG. 5 is an explanatory view showing the relationship among the electrode portions, the electronic part and a printed circuit board in the embodiment of the present invention;

FIG. 6 is an explanatory view showing the positional relationship between the electrical contact portion of each first contact with the electrode terminal of the electronic part and the electrical contact portion of each second contact with the electrode terminal of the printed circuit board, in the embodiment of the present invention;

FIGS. 7A-7C are explanatory views showing the states of the electrode portions in the cases of attaching the printed circuit board and pressing the electronic part in the first embodiment of the present invention, wherein FIG. 7A shows the state of the electrode portions before the electronic part and the printed circuit board are mounted, FIG. 7B shows the state of the electrode portions in the case of attaching the printed circuit board, and FIG. 7C shows the state of the electrode portions in the case of pressing the electronic part;

FIGS. 8A-8E show the situations of mounting the electronic part on the socket body in the embodiment of the present invention, wherein FIG. 8A is an explanatory view showing the relationship between the electronic part and the socket for the electronic part, FIG. 8B is an explanatory view showing the turned state of a socket cover, FIG. 8C is an explanatory view showing the turned state of an operation lever, FIG. 8D is a front view showing a state where the electronic part has been received and fixed in a socket base, and FIG. 8E is a perspective view showing the state where the electronic part has been received and fixed in the socket base;

FIG. 9 is an explanatory view showing the situation of mounting of electrode portions into the recesses of a socket body in the second embodiment of the present invention;

FIG. 10 is a perspective view of the electrode portion in the second embodiment of the present invention;

FIGS. 11A-11C are explanatory views showing the states of the electrode portions in the cases of attaching the printed circuit board and pressing the electronic part in the second embodiment of the present invention, wherein FIG. 11A shows the state of the electrode portions before the electronic part and the printed circuit board are mounted, FIG. 11B shows the state of the electrode portions in the case of attaching the printed circuit board, and FIG. 11C shows the state of the electrode portions in the case of pressing the electronic part;

FIG. 12 is an explanatory view showing the situation of mounting of electrode portions into the recesses of a socket body in the third embodiment of the present invention;

FIG. 13 is a perspective view of the electrode portion in the third embodiment of the present invention;

FIGS. 14A-14C are explanatory views showing the states of the electrode portions in the cases of attaching the printed circuit board and pressing the electronic part in the third embodiment of the present invention, wherein FIG. 14A shows the state of the electrode portions before the electronic part and the printed circuit board are mounted, FIG. 14B shows the state of the electrode portions in the case of attaching the printed circuit board, and FIG. 14C shows the state of the electrode portions in the case of pressing the electronic part; and

FIG. 15 is a fragmentary sectional view of a prior-art socket for an electronic part.

### DESCRIPTION OF THE PREFERRED EMBODIMENTS

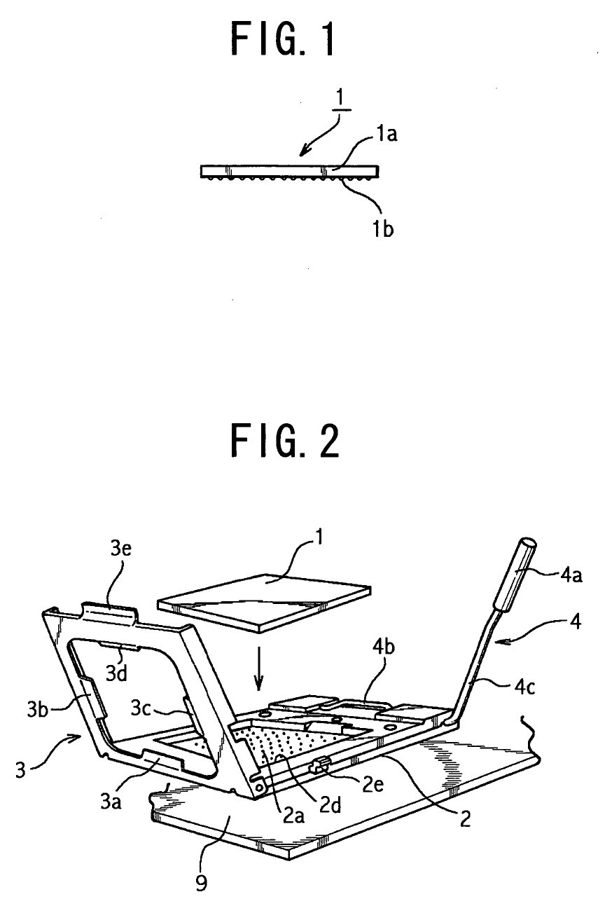

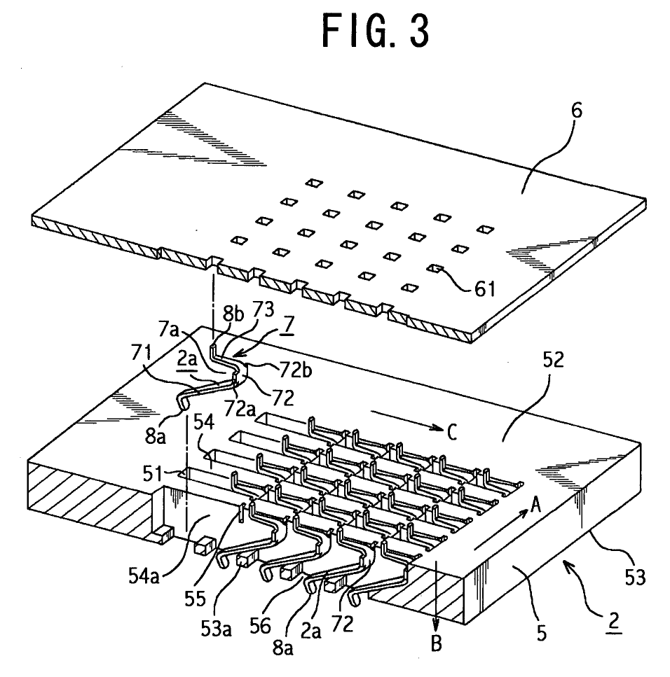

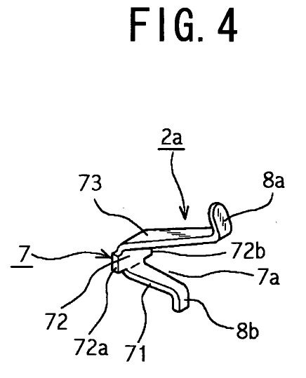

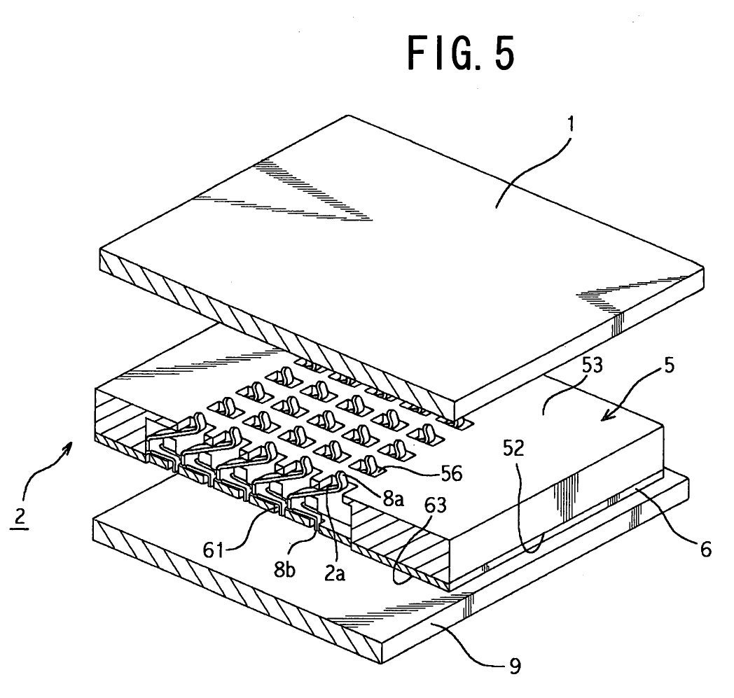

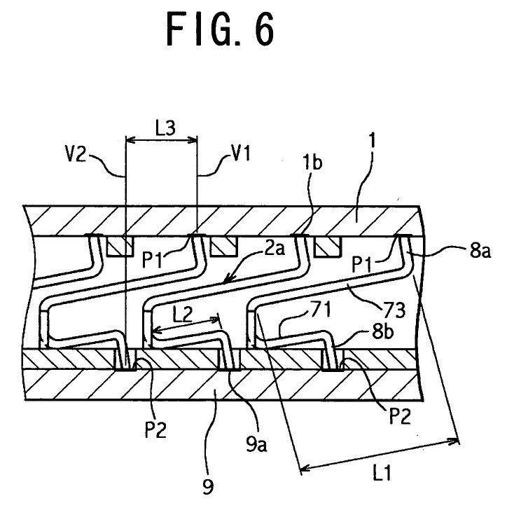

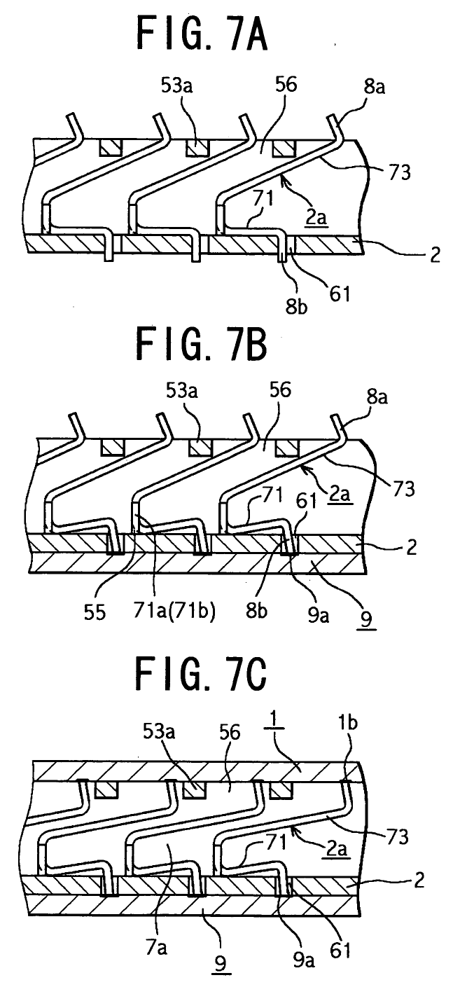

Now, preferred embodiments of a socket for an electronic part according to the present invention will be described in detail with reference to the drawings. Here, FIG. 1 is a side view showing an example of an electronic part, FIG. 2 is a perspective view of a socket for an electronic part showing an embodiment of the present invention, FIG. 3 is an explanatory view showing the situation of mounting of electrode portions into the recesses of a socket body in the first embodiment of the present invention, FIG. 4 is a perspective view of the electrode portion in the first embodiment of the present invention, FIG. 5 is a perspective view showing the relationship among the socket body, the electronic part and a printed circuit board in the first embodiment of the present invention, FIG. 6 is an explanatory view showing the positional relationship between the electrical contact portion of each first contact with the electrode terminal of the electronic part and the electrical contact portion of each second contact with the electrode terminal of the printed circuit board, in the first embodiment of the present invention, and FIGS. 7A-7C are explanatory views showing the states of the electrode portions in the cases of attaching the printed circuit board and pressing the electronic part in the first embodiment of the present invention.

Referring to FIG. 1, an electronic part 1 constructed of, for example, a BGA (Ball Grid Array) includes a package 1a, and a large number of connection terminals 1b which are arrayed in the shape of a grid on the back surface of the package 1a. The connection terminals 1b are made up of spherical solder balls or the likes.

Next, as shown in FIG. 2, a socket for an electronic part according to the present invention includes a socket body 2 which has electrode portions 2a for connections with the electrode terminals 1b (refer to FIG. 1) of the electronic part 1, at substantially the central part of the principal surface thereof, a socket cover 3 which is turnably mounted on one end edge side of the socket body 2, and an operation lever 4 which is turnably mounted on the other end edge side of the socket body 2.

As shown in FIG. 3, the socket body 2 includes a rectangular flat plate member 5, and a plate-like lining member 6 which has the same shape as that of the flat plate member 5 and which is affixed onto the rear surface side of the flat plate member 5. The flat plate member 5 and the lining member 6 are formed of an insulating plastic material or the like.

The flat plate member 5 includes a plurality of laterally long recesses 51 in its rear surface portion 52. The recesses 51 are provided presenting so-called “columns” along the widthwise direction A of the flat plate member 5 and through partition walls 54. Here, each of the recesses 51 is provided extending over a predetermined length (a length equal to about ⅘ of the thickness of the flat plate member 5) in the thickness direction B of the flat plate member 5 from the rear surface portion 52 thereof.

The opposing sidewalls 54a of each recess 51 are provided with pairs of engagement grooves (hereinbelow, termed “first engagement grooves”) 55 at predetermined intervals along the lengthwise direction of the recess 51. Here, each of the first engagement grooves 55 is provided extending over a predetermined length (a length equal to about ⅓ of the thickness of the flat plate member 5) in the thickness direction B of the flat plate member 5 from the rear surface portion 52 thereof.

On the other hand, a plurality of insertion holes (hereinbelow, termed “first insertion holes”) 56 are provided at the position of the upper surface portion 53 of the flat plate member 5 corresponding to each recess 51, at predetermined intervals along the lengthwise direction C of the recess 51. Also, a plurality of insertion holes (hereinbelow, termed “second insertion holes”) 61 are provided at the position of the lining member 6 corresponding to each recess 51, at predetermined intervals along the lengthwise direction C of the recess 51. Thus, the first insertion holes 56 are provided in a grid shape at the upper part of the socket body 2 so as to correspond to the electrode terminals 1b of the electronic part 1, while the second insertion holes 61 are provided in the grid shape at the lower part of the socket body 2 so as to correspond to the electrode terminals 9a (refer to FIG. 6) of a printed circuit board 9 (refer to FIG. 5). In turn, the first insertion holes 56 communicate with the corresponding second insertion holes 61 through the corresponding recesses 51, respectively. Here, the dimension of each of the first insertion holes 56 in the C-direction is set to be about 3-4 times the dimension of the second insertion hole 61 in the C-direction. Besides, the second insertion holes 61 exist at positions which are substantially opposite to the upper surface parts (hereinbelow, termed “hole surrounding portions”) 53a of the flat plate member 5 as exist around the first insertion holes 56, and the first engagement grooves 55 are provided near the second insertion holes 61 which are adjacent on the left side as viewed in the figure.

As shown in FIG. 4, each of electrode portions 2a includes a leaf spring portion 7 into which a conductive plate member is bent substantially in the shape of letter U, and which is disposed with an opening part 7a facing in the direction (lengthwise direction C of the recess 51) substantially perpendicular to the thickness direction B (refer to FIG. 3) of the socket body 2, a first contact 8a which is provided unitarily with one free end of the leaf spring portion 7, and which comes into electrical contact with the electrode terminal 1b of the electronic part 1, and a second contact 8b which is provided unitarily with the other free end of the leaf spring portion 7, and which comes into electrical contact with the electrode terminal 9a of the printed circuit board 9 to be stated later.

The leaf spring portion 7 includes a horizontally extending portion 71 which is arranged substantially in parallel with the horizontal surface of the printed circuit board 9 to be stated later, a coupling portion 72 which is unitarily provided at one end of the horizontally extending portion 71 so as to extend in the thickness direction (B-direction) of the socket body 2, and an obliquely extending portion 73 which is unitarily provided at the end of the coupling portion 72 so as to oppose to the horizontally extending portion 71 and to rise up obliquely toward the side of the electronic part 1. A pair of engagement pieces (hereinbelow, termed “first engagement pieces”) 72a and 72b which engage the first engagement grooves 55 are unitarily provided on both the sides of the coupling portion 72 so as to protrude toward the first engagement grooves 55. Here, the lateral width of the recess 51 (the dimension thereof in the A-direction) is set to be substantially equal to or somewhat larger than the width of the leaf spring portion 7. Besides, the dimension (in the A-direction) between the opposing pair of first engagement grooves 55 is set to be substantially equal to or somewhat larger than the dimension between both the ends of the pair of first engagement pieces 72a and 72b. Incidentally, the groove width of each of the first engagement grooves 55 is set to be substantially equal to or somewhat larger than the plate thickness of the first engagement pieces 72a and 72b.

Subsequently, the distal end part of the obliquely extending portion 73 which constitutes the leaf spring portion 7 is bent toward the side of the electronic part 1 so as to be substantially perpendicular to the obliquely extending portion 73, and the distal end part of the horizontally extending portion 71 is bent toward the side of the printed circuit board 9 so as to be substantially perpendicular to the horizontally extending portion 71. Thus, the first contact 8a which comes into electrical contact with the electrode terminal 1b of the electronic part 1 is formed at the distal end part of the obliquely extending portion 73, and the second contact 8b which comes into electrical contact with the electrode terminal 9a of the printed circuit board 9 to be stated later is formed at the distal end part of the horizontally extending portion 71.

The electrode portion 2a of such a construction can be formed in such a way that one piece of plate material (length: 3 mm, width: 0.5 mm, and thickness: 0.06-0.08 mm) made of, for example, phosphor bronze is subjected to bending work.

Next, there will be described a method for disposing each of the electrode portions 2a in the corresponding recess 51 of the socket body 2. First, the flat member 5 is inverted as shown in FIG. 3, whereby the opening parts of the recesses 51 provided in the shape of the columns are faced upwards. Subsequently, each of the electrode portions 2a is received into the corresponding recess 51 with its own opening part 7a facing in the lengthwise direction C of the recess 51, that is, with the pair of first engagement pieces 72a and 72b facing to the sides of the corresponding ones of the pair of first engagement grooves 55. Simultaneously, the pair of first engagement pieces 72a and 72b are respectively brought into engagement with the corresponding ones of the pair of first engagement grooves 55. Thus, as shown in FIG. 5, the distal end part of the first contact 8a of each electrode portion 2a passes through the corresponding first insertion hole 56, and it protrudes about 0.3 mm beyond the upper surface portion 53 of the flat plate member 5. Also, the distal end part of the second contact 8b protrudes about 0.6 mm beyond the rear surface portion 52 of the flat plate member 5.

In this way, the electrode portions 2a have been respectively received in the corresponding recesses 51 and disposed in the shape of the grid. Thereafter, the lining member 6 is molded on the rear surface portion 52 of the flat member 5 so as to become unitary with this member 5. Thus, as shown in FIG. 5, the distal end parts of the second contacts 8b of the electrode portions 2a pass through the corresponding second insertion holes 61, respectively, until they protrude about 0.25 mm beyond the rear surface portion 63 of the lining member 6.

Here in the first embodiment, as shown in FIG. 6, the lengthwise dimension L1 of the obliquely extending portion 73 constituting the electrode portion 2a is set to be nearly double the lengthwise dimension L2 of the horizontally extending portion 71. Thus, as will be stated later, the electrical contact (hereinbelow, termed “first electrical contact portion”) P1 between the first contact 8a and the electrode terminal 1b of the electronic part 1 exists at an oblique upper position as viewed from the electrical contact (hereinbelow, termed “second electrical contact portion”) P2 between the second contact 8b and the electrode terminal 9a of the printed circuit board 9. That is, a vertical line V1 which passes through the first electrical contact portion P1 exists at a position spaced a predetermined length L3 (about 0.5 mm) in the lengthwise direction C from a vertical line V2 which passes through the second electrical contact portion P2.

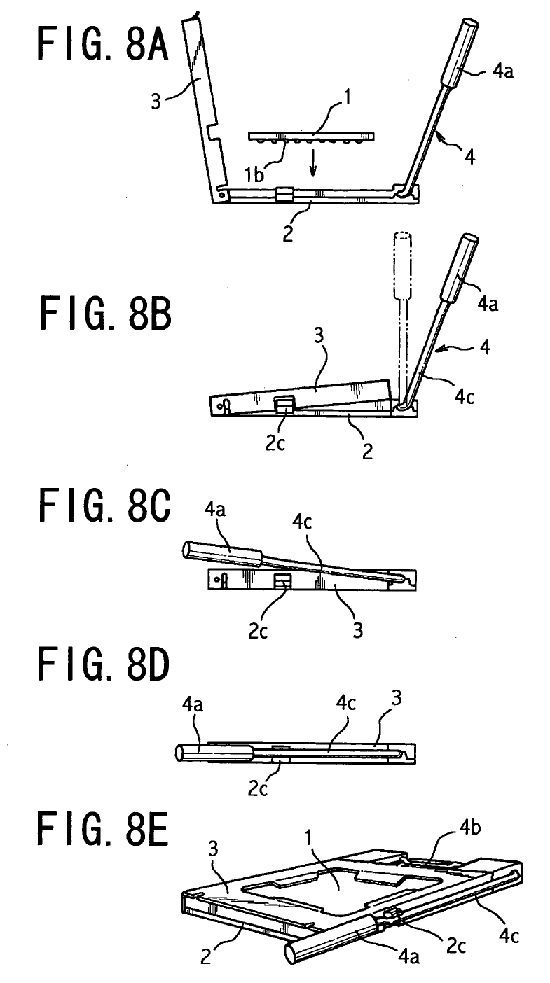

Next, a method for electrically connecting the electrode terminals 1b of the electronic part 1 and the electrode terminals 9a of the printed circuit board 9 through the electrode portions 2a will be described with reference to FIG. 2, FIGS. 7A-7C and FIGS. 8A-8E. Incidentally, for the brevity of description, FIGS. 7A-7C illustrate the electrode portions 2a in the number of three, and the electrode terminals 1b of the electronic part 1 and the electrode terminals 9a of the printed circuit board 9 as correspond to these electrode portions 2a.

First, as shown in FIG. 7A, the distal end part of the first contact 8a of each electrode portion 2a protrudes beyond the upper surface portion of the socket body 2, and the distal end part of the second contact 8b protrudes beyond the rear surface portion of the socket body 2. In this state, as shown in FIG. 7B, the socket body 2 is placed on the printed circuit board 9 so that the distal end parts of the second contacts 8b of the electrode portions 2a may come into electrical contact with the corresponding electrode terminals 9a of the printed circuit board 9, and the socket body 2 is simultaneously pushed against the side of the printed circuit board 9. Then, since the pair of first engagement pieces 71a and 71b constituting each electrode portion 2a are fixed by the pair of first engagement grooves 55, the second contact 8b sides of the horizontally extending portions 71 of the electrode portions 2a come to somewhat float from the upper surface of the printed circuit board 9 in the state where the electrical contact between the distal end parts of the second contacts 8b of the electrode portions 2a and the electrode terminals 9a of the printed circuit board 9 is held.

Subsequently, as shown in FIG. 8A, the electronic part 1 is received into the concave portion 2d (refer to FIG. 2) of the socket body 2, and the free end of the socket cover 3 is turned toward the side of one end edge portion of the socket body 2 (onto the right side as viewed in the figure). Thus, as shown in FIG. 7C, the electrode terminals 1b of the electronic part 1 and the distal end parts of the first contacts 8a of the electrode portions 2a come into electrical contact, and the electronic part 1 is lightly pressed by a first pawl 3a (refer to FIG. 2) which is provided in the socket cover 3. Besides, the free end of the socket cover 3 is pushed toward the end edge portion of the socket body 2 (onto the right side as viewed in the figure), and the grip member 4a of the operation lever 4 is partially turned toward the side of the other end edge portion of the socket body 2 (onto the left side as viewed in the figure) as indicated by two-dot chain lines, until a turning push portion 4b (refer to FIG. 2) provided in the operation lever 4 is brought into engagement with a depressed portion 3e (refer to FIG. 2) which is provided on the free end side of the socket cover 3. Thus, the electronic part 1 is fixed by first-fourth pawls 3a-3d (refer to FIG. 2) provided in the socket cover 3, in the state where the electrical contact between the electrode terminals 1b of the electronic part 1 and the distal end parts of the first contacts 8a of the electrode portions 2a is held as shown in FIG. 7C. Subsequently, as shown in FIG. 8C, the grip member 4a of the operation lever 4 is further turned toward the side of the other end edge portion of the socket body 2. When the arm portion 4c of the operation lever 4 has arrived over a hook portion 2e provided on the side edge portion of the socket body 2, it is somewhat shifted in the widthwise direction of the socket body 2. As shown in FIG. 8D, the grip member 4a is further pushed down to bring the arm portion 4c into engagement with the hook portion 2e. FIG. 8E shows a state where the electronic part 1 has been received and fixed within the socket body 2 in this way.

In the above way, the first contacts 8a of the electrode portions 2a are pushed into the recesses 51 of the socket body 2 as shown in FIG. 7C, whereby the obliquely extending portions 73 of the electrode portions 2a are displaced toward the sides of the horizontally extending portions 71. That is, the opening degree of the opening parts 7a of the leaf spring portions 7 constituting the electrode portions 2a is narrowed, and in turn, spring forces toward the side of the electronic part 1 are urged against the obliquely extending portions 73. Incidentally, when the electronic part 1 is detached from the socket body 2, the distal end parts of the first contacts 8a protrude beyond the upper surface portion of the socket body 2 as shown in FIG. 7B, owing to the spring forces of the obliquely extending portions 73 of the electrode portions 2a. Further, when the socket body 2 is detached from the printed circuit board 9, the distal end parts of the second contacts 8b protrude beyond the rear surface portion of the socket body 2 as shown in FIG. 7A.

As described above, according to the first embodiment of the present invention, each electrode portion is constructed of a single piece and is structurally simplified, so that the workability and assemblability of the electrode portion can be sharply enhanced, and the cost thereof becomes comparatively low. Moreover, the electrical contact portion between each first contact and the corresponding electrode terminal of an electronic part exists at an oblique upper position as viewed from the electrical contact portion between each second contact and the corresponding electrode terminal of a printed circuit board, so that the dimension of a leaf spring portion in the lengthwise direction thereof can be set large. In turn, even when the thickness of a socket body itself is small, each electrode terminal of the electronic part and the corresponding electrode terminal of the printed circuit board can be reliably brought into electrical contact, and a stable contact resistance can be attained.

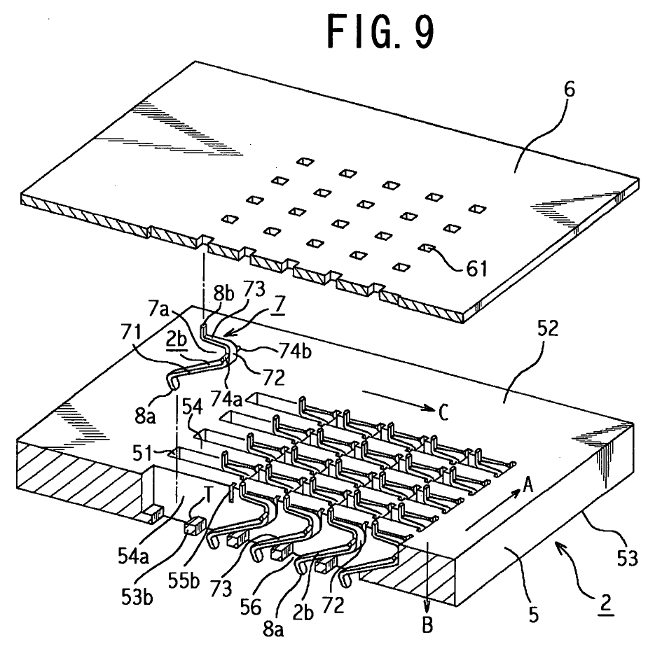

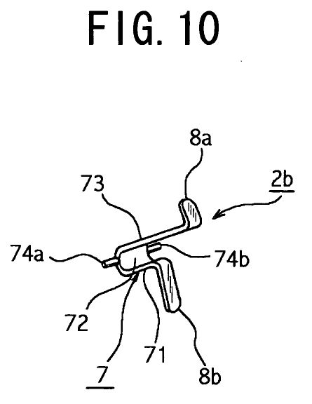

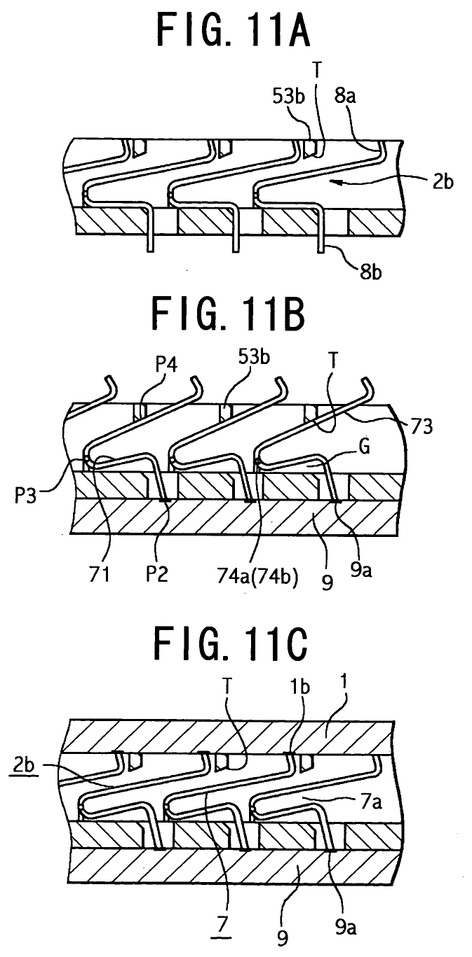

FIG. 9 is an explanatory view showing the situation of mounting of electrode portions into the recesses of a socket body in the second embodiment of the present invention, FIG. 10 is a perspective view of the electrode portion in the second embodiment of the present invention, and FIGS. 11A-11C are explanatory views showing the states of the electrode portions in the cases of attaching a printed circuit board and pressing an electronic part in the second embodiment of the present invention. Incidentally, throughout these figures, the same reference numerals and signs are assigned to parts which are common to the parts in FIG. 3-FIG. 7C.

In the second embodiment, hole surrounding portions 53b each having a taper T as shown in FIG. 9 are formed instead of the hole surrounding portions 53a of the flat plate member 5 as shown in FIG. 3, and an electrode portion 2b shown in FIG. 10 is used instead of the electrode portion 2a shown in FIG. 4.

In the second embodiment, as shown in FIG. 9, that corner of the hole surrounding portion 53b of the flat plate member 5 which opposes to the obliquely extending portion 73 of the electrode portion 2b is formed with the taper T which rises up obliquely from the left side toward the right side as viewed in the figure. Besides, the opposing sidewalls 54a of each recess 51 of the flat member 5 are formed with bearings 55b which are constructed similarly to the pairs of first engagement grooves 55 (refer to FIG. 3) stated before. Further, shafts 74a and 74b each of which has a diameter somewhat smaller than the groove width of the bearing 55b are unitarily provided at both the side parts of the coupling portion 72 of each leaf spring portion 7 constituting the electrode portion 2b, so as to protrude toward the sides of the bearings 55b.

In the electrode portion 2b thus constructed, the pair of shafts 74a and 74b provided at both the side parts of the coupling portion 72 are rotatably supported in the corresponding pair of bearings 55b. According to the second embodiment, therefore, the leaf spring portion 7 constituting the electrode portion 2b is entirely endowed with an elasticity as will be stated below, so that the spring force of the electrode portion 2b for an electronic part and a printed circuit board can be increased still more than in the first embodiment.

In the second embodiment, first of all, as shown in FIG. 11A, the distal end parts of the first contacts 8a of the electrode portions 2b do not protrude beyond the upper surface portion of a socket body 2, and only the distal end parts of the second contacts 8b protrude beyond the rear surface portion of the socket body 2. In this state, as shown in FIG. 11B, the socket body 2 is placed on the printed circuit board 9 so that the distal end parts of the second contacts 8b of the electrode portions 2b may come into electrical contact with the electrode terminals 9a of the printed circuit board 9, and the socket body 2 is simultaneously pushed against the side of the printed circuit board 9. Then, the obliquely extending portions 73 constituting the electrode portions 2b rotate with the bearing portions P3 of the shafts 74a (74b) as fulcra, up to parts (hereinbelow, termed “abutment parts”) P4 where these obliquely extending portions 73 abut against the taper portions T of the hole surrounding portions 53b. Thus, the elasticity is bestowed on each leaf spring portion 7 which extends from the abutment part P4 to a second electrical contact portion P2. In turn, the second contact 8b side of the horizontally extending portion 71 of the electrode portion 2b floats from the upper surface of the printed circuit board 9 so as to have a gap G larger than in the case of the first embodiment, with the bearing portion P3 as the fulcrum and in the state where the electrical contact between the distal end part of the second contact 8b of the electrode portion 2b and the electrode terminal 9a of the printed circuit board 9 is held.

Subsequently, as in the first embodiment, the electronic part 1 is received into the concave portion 2d (refer to FIG. 2) of the socket body 2, and it is pushed onto the printed circuit board side. Then, as shown in FIG. 11C, the electrode terminals 1b of the electronic part 1 and the distal end parts of the first contacts 8a of the corresponding electrode portions 2b are brought into electrical contact, and the first contacts 8a of the electrode portions 2b are pushed into the recesses 51 of the socket body 2, whereby the obliquely extending portions 73 of the electrode portions 2b are displaced toward the sides of the horizontally extending portions 71. That is, the opening degree of the opening parts 7a of the leaf spring portions 7 constituting the electrode portions 2b is narrowed, and in turn, spring forces toward the side of the electronic part 1 and the side of the printed circuit board 9 are urged against the whole leaf spring portions 7.

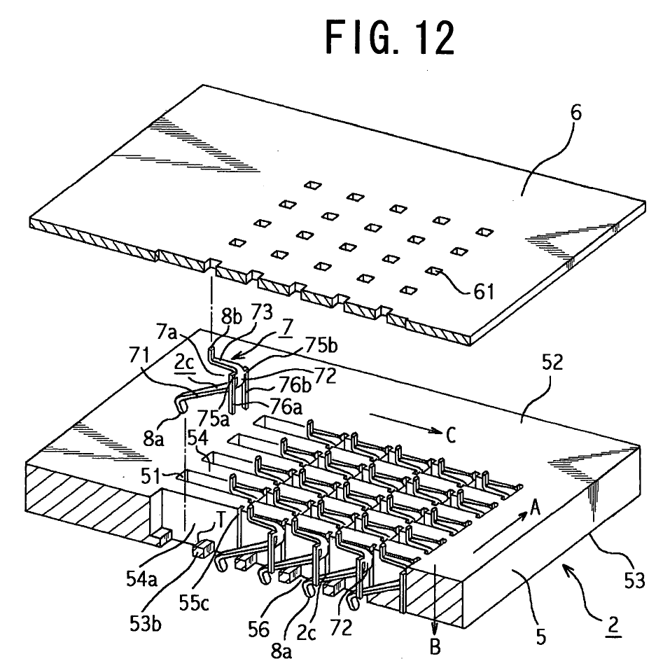

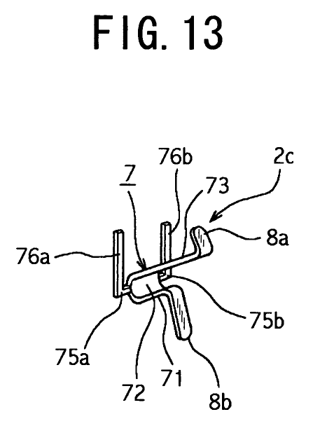

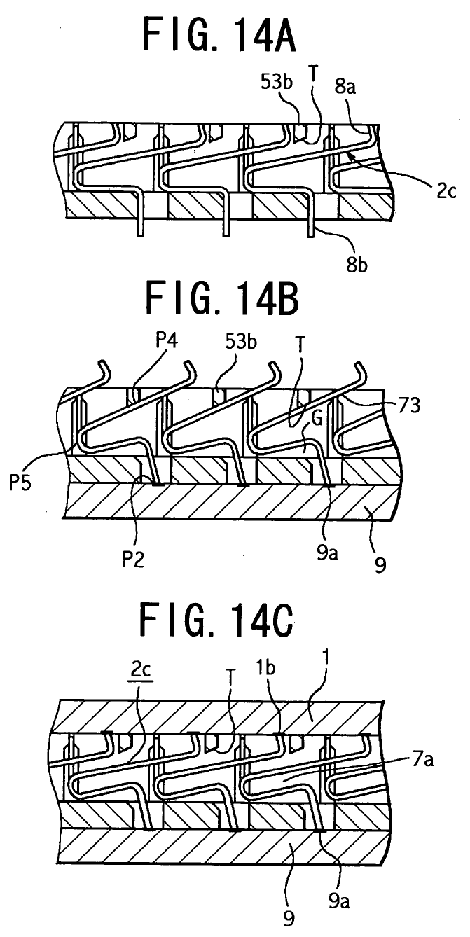

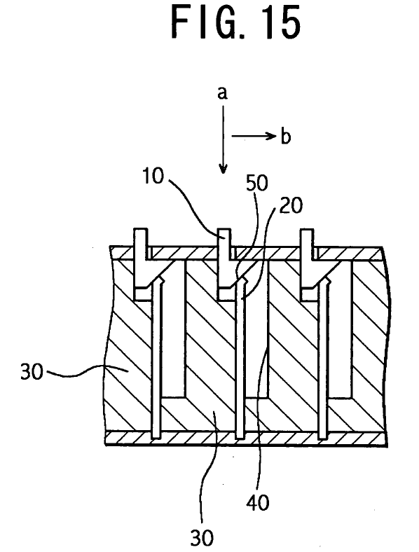

FIG. 12 is an explanatory view showing the situation of mounting of electrode portions into the recesses of a socket body in the third embodiment of the present invention, FIG. 13 is a perspective view of the electrode portion in the third embodiment of the present invention, and FIGS. 14A-14C are explanatory views showing the states of the electrode portions in the cases of attaching a printed circuit board and pressing an electronic part in the third embodiment of the present invention. Incidentally, throughout these figures, the same reference numerals and signs are assigned to parts which are common to the parts in FIG. 3-FIG. 11C.

Referring to FIG. 12, in the third embodiment, hole surrounding portions 53b each having a taper T as are similar to the hole surrounding portions 53b of the flat plate member 5 shown in FIG. 9 are formed, and an electrode portion 2c shown in FIG. 13 is used instead of the electrode portion 2a shown in FIG. 4.

In the third embodiment, as shown in FIG. 12, the opposing sidewalls 54a of each recess 51 of the flat plate member 5 are formed with pairs of engagement grooves (hereinbelow, termed “second engagement grooves”) 55c each of which is longer than the first engagement groove 55 (refer to FIG. 3) (each of which is nearly equal to the depthwise dimension of the recess 51). Besides, as shown in FIG. 13, both the side parts of the coupling portion 72 of a leaf spring portion 7 constituting the electrode portion 2c are provided with extension pieces 75a and 75b which are formed unitarily with the coupling portion 72 toward the sides of the sidewalls 54a of each recess 51, and a pair of engagement pieces (hereinbelow, termed “second engagement pieces”) 76a and 76b which are formed unitarily with the coupling portion 72 at the end parts of the extension pieces 75a and 75b and in parallel with the sidewalls 54a.

In the electrode portion 2c thus constructed, the pair of second engagement pieces 76a and 76b provided at both the side parts of the coupling portion 72 are respectively held in engagement with the corresponding second engagement grooves 55c. According to the third embodiment, therefore, the leaf spring portion 7 constituting the electrode portion 2c is entirely endowed with an elasticity as will be stated below, and the second engagement pieces 76a and 76b are endowed with torsional forces, so that the spring force of the electrode portion 2c for an electronic part and a printed circuit board can be increased still more than in the second embodiment.

In the third embodiment, first of all, as shown in FIG. 14A, the distal end parts of the first contacts 8a of the electrode portions 2c do not protrude beyond the upper surface portion of a socket body 2, and only the distal end parts of the second contacts 8b protrude beyond the rear surface portion of the socket body 2. In this state, as shown in FIG. 14B, the socket body 2 is placed on the printed circuit board 9 so that the distal end parts of the second contacts 8b of the electrode portions 2c may come into electrical contact with the electrode terminals 9a of the printed circuit board 9, and the socket body 2 is simultaneously pushed against the side of the printed circuit board 9. Then, the obliquely extending portions 73 constituting the electrode portions 2c rotate with the engagement parts P5 of the second engagement pieces 76a (76b) as fulcra, up to parts (hereinbelow, termed “abutment parts”) P4 where these obliquely extending portions 73 abut against the taper portions T of the hole surrounding portions 53b. Thus, the elasticity is bestowed on each leaf spring portion 7 which extends from the abutment part P4 to a second electrical contact portion P2. In turn, the second contact 8b side of the horizontally extending portion 71 of the electrode portion 2c floats from the upper surface of the printed circuit board 9 so as to have a gap G larger than in the case of the first embodiment, with the engagement part P5 as the fulcrum and in the state where the electrical contact between the distal end part of the second contact 8b of the electrode portion 2c and the electrode terminal 9a of the printed circuit board 9 is held.

Subsequently, as in the first embodiment, the electronic part 1 is received into the concave portion 2d (refer to FIG. 2) of the socket body 2, and it is pushed onto the printed circuit board side. Then, as shown in FIG. 14C, the electrode terminals 1b of the electronic part 1 and the distal end parts of the first contacts 8a of the corresponding electrode portions 2c are brought into electrical contact, and the first contacts 8a of the electrode portions 2c are pushed into the recesses 51 of the socket body 2, whereby the obliquely extending portions 73 of the electrode portions 2c are displaced toward the sides of the horizontally extending portions 71. That is, the opening degree of the opening parts 7a of the leaf spring portions 7 constituting the electrode portions 2c is narrowed, and in turn, spring forces toward the side of the electronic part 1 and the side of the printed circuit board 9 are urged against the whole leaf spring portions 7.

By the way, in each of the foregoing embodiments, the electrode terminals 1b of the electronic part 1 are held in electrical contact with the first contacts 8a of the electrode portions 2a, 2b or 2c, and the second contacts 8b of the electrode portions 2a, 2b or 2c are held in electrical contact with the electrode terminals 9a of the printed circuit board 9, but it is also allowed to hold the electrode terminals 9a of the printed circuit board 9 in electrical contact with the first contacts 8a of the electrode portions 2a, 2b or 2c, and to hold the second contacts 8b of the electrode portions 2a, 2b or 2c in electrical contact with the electrode terminals 1b of the electronic part 1. Moreover, the electronic part 1 is not restricted to the BGA, but it may well be, for example, an LGA (Land Grid Array), a CSP (Chip Size Package), a PGA (Pin Grid Array) or a micro PGA.

As understood from the above description, according to the socket of the present invention for use with an electronic part, each electrode portion is constructed of a single piece and is structurally simplified, so that the workability and assemblability of the electrode portion can be sharply enhanced, and the cost thereof becomes comparatively low. Moreover, the electrical contact portion between each first contact and the corresponding electrode terminal of the electronic part (or a printed circuit board) exists at an oblique upper position as viewed from the electrical contact portion between each second contact and the corresponding electrode terminal of the printed circuit board (or the electronic part), so that the dimension of a leaf spring portion in the lengthwise direction thereof can be set large. In turn, even when the thickness of a socket body itself is small, each electrode terminal of the electronic part and the corresponding electrode terminal of the printed circuit board can be reliably brought into electrical contact, and a stable contact resistance can be attained.

1. A socket for an electronic part, having electrode portions which are disposed in recesses of a socket body and which are connected to electrode terminals of the electronic part and electrode terminals of a printed circuit board;
each of the electrode portions comprising a leaf spring portion which is disposed by bending a plate material substantially into a U-shape and facing an opening part in a direction substantially perpendicular to a thickness direction of the socket body, a first contact which is unitarily provided at one free end of said leaf spring portion and which is held in electrical contact with the corresponding electrode terminal of one of the electronic part and the printed circuit board, and a second contact which is unitarily provided at the other free end of said leaf spring portion and which is held in electrical contact with the corresponding electrode terminal of the other of the electronic part and the printed circuit board;
an electrical contact portion of said first contact with the corresponding electrode terminal of said one of the electronic part and the printed circuit board being existent at an oblique upper position as viewed from an electrical contact portion of said second contact with the corresponding electrode terminal of said other of the electronic part and the printed circuit board.

2. A socket for an electronic part as defined in claim 1, wherein:
said leaf spring portion includes a horizontally extending portion which is arranged substantially in parallel with a horizontal surface of said other of the printed circuit board and the electronic part, a coupling portion which is unitarily provided at one end part of said horizontally extending portion in the thickness direction of the socket body, and an obliquely extending portion which is unitarily provided at an end part of said coupling portion so as to oppose to said horizontally extending portion and to obliquely rise up toward said one of the electronic part and the printed circuit board;
said first contact is constructed by bending a distal end part of said obliquely extending portion toward said one of the electronic part and the printed circuit board; and
said second contact is constructed by bending a distal end part of said horizontally extending portion toward said other of the electronic part and the printed circuit board.

3. A socket for an electronic part as defined in claim 1, wherein a dimension of said obliquely extending portion in a lengthwise direction thereof is set to be longer than a dimension of said horizontally extending portion in a lengthwise direction thereof.

4. A socket for an electronic part as defined in claim 1, wherein said leaf spring portion includes first engagement pieces which are provided unitarily with its own side parts toward sidewalls of the recess, and said first engagement pieces are held in engagement with first engagement grooves which are provided in the sidewalls.

5. A socket for an electronic parts as defined in claim 1, wherein said leaf spring portion includes shafts which are provided unitarily with its own side parts toward sidewalls of the recess, and said shafts are rotatably supported by bearings which are provided in the sidewalls.

6. A socket for an electronic part as defined in claim 1, wherein said leaf spring portion includes extension pieces which are provided unitarily with its own side parts toward sidewalls of the recess, and second engagement pieces which are provided unitarily with end parts of said extension pieces in parallel with the sidewalls, and said second engagement pieces are held in engagement with second engagement grooves which are provided in the sidewalls.
